(19) United States
(12) Patent Application Publication
(10) Pub. No.: US 2022/0333863 A1
(43) Pub. Date: Oct. 20, 2022

(54) ENERGY RECOVERY FROM CONTACT DRYERS

(71) Applicant: CARGILL, INCORPORATED, Wayzata, MN (US)

(72) Inventors: Jan Foeke KIKSTRA, Halsteren (NL); Norbertus Philippus KOOT, Roosendaal (NL); Thomas LIEFTING, Terneuzen (NL)

(73) Assignee: CARGILL, INCORPORATED, Wayzata, MN (US)

(21) Appl. No.: 17/753,156

(22) PCT Filed: Aug. 31, 2020
(86) PCT No.: PCT/US2020/048680

§ 371 Date: Feb. 22, 2022

(30) Foreign Application Priority Data
Aug. 30, 2019 (EP) 19194697.9

(51) Int. Cl. F26B 23/00; F26B 11/02

(52) U.S. Cl. CPC F26B 23/004; F26B 11/02

(57) ABSTRACT

The present invention relates to installations comprising a contact dryer and a vapour compressor. The invention also covers processes using an installation comprising a contact dryer and a vapour compressor for drying a water-containing composition of solid matter with a higher energy efficiency. Furthermore, the invention relates to the field of energy recovery from contact dryers.

### TECHNICAL FIELD OF THE INVENTION

The present invention relates to the field of energy recovery from contact dryers and processes for drying a water-containing composition of solid matter in a contact dryer with recovered energy.

### BACKGROUND OF THE INVENTION

Drying is a complicated process that involves simultaneous heat and mass transfer for the vaporization of water from a solution, suspension, or other solid-liquid mixture to form a dry solid. This process is often used as a final production step before selling or packaging products.

The drying step reduces the solute or moisture level to improve the storage and handling characteristics of the product, maintain product quality during storage and transportation, and to reduce transport costs (less water and therefore weight and volume to transport).

In direct drying processes a gaseous stream of hot air applies the heat by convection and carries away the vapor as humidity. EP2511636A1 discloses a direct dryer in which superheated steam is put into direct contact with the wet product to be dried. There is no wall or physical separation between the wet product and the superheated steam. Direct drying however is not always the preferred method of drying.

In indirect drying processes, such as in contact dryers, saturated steam is often used as the energy source. In such processes, heat is supplied from saturated steam via a hot surface in contact with the composition of solid matter to be dried. Some of the advantages of indirect/contact dryers are that:
It avoids the issue of fine materials becoming entrained in the process vapours.
The processing environment can be more tightly controlled, an ideal characteristic when working with materials that can be combustible in certain settings.
Food-grade materials, which should not come into contact with process vapours to avoid contamination, can be dried.

Contact dryers known in the art suffer from the problem that due to their construction a lot of the employed energy to produce the vapours, typically water vapour/steam, is not recovered. This is particularly the case when a contact dryer is not connected to other external processes but is used as standalone system. This makes drying a very energy intensive process. Drying, in general, has been reported to account for anywhere from 12 to 20% of the energy consumption in the industrial sector. There is thus a need to make these processes more energy efficient, for instance by energy recovery.

Technologies have emerged to improve the energy efficiency of drying. One such example is superheated steam drying, as also described in EP2511636A1 applied in a direct drying system. However, the application of superheated steam drying strongly depends on the product characteristics. A considerable draw-back of superheated steam drying is the high temperature impact on the product in order to recover enough energy in the form of heat. The high temperatures used means that this process is not suitable for drying food or feed products. The heat captured at lower temperatures would not be enough to be reused in the same drying process and would typically be only used to provide energy in another unrelated process. Therefore, superheated steam drying does not represent a suitable solution for a stand-alone unit using energy recovery, particularly for drying food-grade or feed-grade products.

Vapor screw compressors are known for their use in various parts of the chemical industry, in breweries and in distilleries to recover the latent heat of vaporisation during the distillation process for instance from a wort kettle. However, the use of a vapor compressor, preferably in an open system, together with a contact dryer, has not been disclosed before. The combination of such technologies is not evident due to various challenges arising from the use of a vapour compressor:
Impurities/particles from the product being dried, which are entrained in the process vapours are transported to the compressor, where they may cause considerable wear and damage;
Non-condensables (mainly air released from the product being dried) building up in the process vapours, thereby reducing drying temperatures, heat transfer capacity and reducing the amount of energy that can thus be recovered;
Without being bound by theory, the dryer operating at lower temperatures, creates a smaller delta T between the compressor and the dryer. The lower temperature difference allows the whole system to be run at a higher efficiency. However, to achieve the same capacity, the size of the dryer needs to be increased considerably; and
Depending on the characteristics of the product being dried, acidity in the process vapours means that conventional contact dryers are not equipped to deal with such harsh conditions, and this is often the case for food or feed products;

US20180172348 discloses extruding a material through a screw extruder in a flow drying apparatus to extract the moisture content (See description of FIGS. 1-19). There is no disclosure of a vapour compressor that compresses vapours coming from the flow drying apparatus.

Accordingly, it is an object of the present invention to provide an installation and/or process for drying water-containing compositions of solid matter, which requires less energy consumption than conventional contact dryers.

It is furthermore an object of the present invention to provide an installation and/or process for drying water-containing compositions of solid matter, which can recover the latent heat of vaporisation from the process vapours originating from a contact dryer.

It would also be desirable to provide an energy-efficient drying installation that is not dependant on being connected to other external thermal processes for energy recovery, such that it can stand alone and be used independently in an energy-efficient manner.

It is also desirable that such an installation can be utilized under large-scale industrial conditions i.e. withstand the harsh conditions of process vapours (typically water vapor) and the inherent impurities/particles and possible acidity that may originate from the product to be dried.

### SUMMARY OF THE INVENTION

The foregoing and other objects are at least partially solved by the provision of an installation suitable for drying a water-containing composition of solid matter comprising:
(i) one or more contact dryer(s) (1) suitable for drying said composition of solid matter using the heat of vaporisation from process vapours;
(ii) a vapour compressor (5) suitable for compressing the process vapours to increase the temperature and pressure of said process vapours;
   wherein the process vapour outlet (1.3) of the one or more contact dryer(s) (1) is connected either directly or indirectly to the process vapour inlet of the vapour compressor (5) and the process vapour outlet of the vapour compressor is connected either directly or indirectly to the process vapour inlet (1.4) of the one or more contact dryer(s) (1).

The contact dryer comprises a process vapour inlet (1.4) and a process vapour outlet (1.3). The vapour compressor (5) comprises a process vapour inlet and a process vapour outlet.

More in particular, the installation suitable for drying a water-containing composition of solid matter preferably further comprises one or more purifying apparatus(es) and:
(iii) a first connecting means (2) suitable for transferring process vapours from said one or more contact dryer(s) to said one or more purifying apparatus(es) (3);
(iv) said one or more purifying apparatus(es) (3) being suitable for reducing the level of any impurities/particles present in the process vapours;
(v) a second connecting means (4) suitable for transferring purified vapours from said one or more purifying apparatus(es) to the vapour compressor (5);
(vi) optionally a means (7) suitable for injecting fresh vapours into a third connecting means (6), which connects the vapour compressor to the one or more contact dryer(s) (1).

The invention also covers a process suitable for drying a water-containing composition of solid matter, preferably using the installation of the invention, comprising the following steps:
(i) drying the composition of solid matter in a contact dryer wherein the heat for drying the composition is generated from process vapours and optionally fresh vapours;
(ii) optionally transferring the process vapours from the contact dryer to one or more purifying apparatus(es) to reduce the level of any impurities/particles in the process vapours in said purifying apparatus(es) before transferring the purified process vapours from said purifying apparatus(es) to a vapour compressor;
(iii) compressing the (optionally purified) process vapours in a vapour compressor, preferably in a one-stage process;
(iv) transferring the compressed process vapours into the contact dryer;
(v) optionally injecting fresh vapours into the (third) connecting means, which connects the vapour compressor to the contact dryer; and
(vi) recovering from the contact dryer a dried composition of solid matter.

The invention also covers the following uses and processes, which can be combined with any of the preferred features provided above and in the description below:
A process for improving the energy efficiency of a contact dryer by using a vapour compressor capable of at least partially recovering the heat of vaporisation from the process vapours originating from the contact dryer, wherein the recovered heat of vaporisation is used in the same contact dryer for drying.
The use of a vapour compressor in an installation comprising a contact dryer for drying water-containing compositions of solid matter to recover at least partially the heat of vaporisation from the process vapours originating from the contact dryer, wherein the recovered heat of vaporisation is used in the same contact dryer for drying.
The use of a vapour compressor in an installation comprising a contact dryer for drying water-containing compositions of solid matter to increase the energy efficiency of the installation compared to the same installation, which does not comprise a vapour compressor, and/or compared to the same installation, comprising a heat pump circuit with a vapour compressor.

This invention thus concerns the new application of a compressor in a contact drying system. The vapour from the drying process is recompressed with a compressor so it can be re-used for drying in the same system, thereby creating an energy-efficient stand-alone unit.

### BRIEF DESCRIPTION OF THE DRAWING

FIG. 1 illustrates an installation discussed in connection with Example 1.

### DETAILED DESCRIPTION OF THE INVENTION

### 1. The Composition of Solid Matter to be Dried

The installation according to the invention is suitable for drying a water-containing composition of solid matter. The word “composition” as used herein is synonymous with substrate, product or the like. Solid matter is synonymous herein with solids, solid or non-liquid materials or substances and the like, that are in the solid state at ambient temperature.

The composition of solid matter to be dried can be in any form: as an emulsion, suspension, paste or other viscous form; in a powder, particulate or particle form, which may be for example granular, gritty, grainy, fine or coarse; in pelletized form; in extruded form, such as in continuous sheets, bands, strands, or filaments etc. Preferably, the composition is in a powder, particulate or particle form. The composition of solid matter can be crystalline, semi-crystalline, amorphous or mixtures thereof. The composition of solid matter may retain its form after using the installation or drying process according to the invention.

The composition of solid matter can be selected from organic matter (such as biological matter or biomaterials)), carbon-based polymers (such as plastics) or inorganic matter (such as metals, ceramics or composite materials).

Preferably, the composition of solid matter is a composition of food or feed and more preferably feed.

For example, the solid matter or composition of solid matter can be selected from:
stillage obtained during the preparation of starches and sweeteners from cereals, such as corn or wheat;
cereals, cereal grains, cereal endosperms, cereal germs, cereal bran or cereal derived products like cereal flakes, starches (native or modified), maltodextrins, syrups and the like, wherein the cereal can be corn or maize, rice, wild rice, wheat (including spelt, einkorn, emmer, durum, kamut and the like), barley, sorghum, millet, oats, rye, triticale, and the like and mixtures thereof;
distillers grains, including wet distillers grains (WDG) and dried distillers grains with solubles (DDGS), i.e. cereal byproduct of the distillation process from beer breweries, distilleries and bioethanol plants, wherein the cereal can be corn or maize, rice, wild rice, wheat (including spelt, einkorn, emmer, durum, kamut and the like), barley, sorghum, millet, oats, rye, triticale and the like and mixtures thereof;
fibrous material comprising fibres such as wood fibres (including groundwood, lacebark, thermomechanical pulp, bleached or unbleached kraft or sulfite pulps and the like), vegetable fibres (including bamboo, cotton, hemp, jute, flax, ramie, sisal, bagasse, banana and coconut fibres and the like), dietary fibres (including soluble fibres and insoluble fibres whether synthetic or natural or derived naturally or derived from nature), animal fibres and the like;
other foodstuffs and fat- and/or protein- and/or lipid- and/or dietary fibre-containing compositions;
detergents in the form of washing powders and
salt, whether mined or produced from seawater.

The installation and process according to the invention are suitable for drying a composition of solid matter containing water that needs to be at least partially removed. A “dried” composition of solid matter as defined herein, is a composition of solid matter that has a lower moisture content than before the drying process according to the invention.

Any amount of water reduction in the composition of solid matter can be achieved according to the desired product specifications. The skilled person will know how to operate the contact dryer in order to obtain the final desired water content of the composition of solid matter, depending on the characteristics of the composition of solid matter.

As a non-limiting example, in the case of stillage obtained during the preparation of starches and sweeteners from cereals, such as corn or wheat, the stillage before drying typically contains only 10-20% of dry substance. After drying in a contact dryer, the stillage may contain more than 80% of dry substance.

### 2. The Installation

2.1. The Contact Dryer

The installation according to the invention comprises a contact dryer. By a “contact dryer” it is meant herein a dryer that provides heat indirectly to the composition, for example, through a wall. These are also known as indirect dryers. According to the invention, hot process vapours (preferably steam, more preferably saturated steam), are passed through the dryer (for instance through tubes or through steam jacketing), thereby heating a surface. The composition of solid matter to be dried passes over the other side of the heated surface, thereby being heated to temperatures that allow the water in the composition to evaporate. At no point is the composition of solid matter in direct contact with the hot process vapours. The condensate of the hot process vapours can be removed, for example, via a exhaust gas stream.

In fact, the invention can be applied to all contact dryers, which do not require direct application of (hot) air or other heat transferring medium to the product to be dried. Other examples of contact or indirect dryers that can be used are, steam-belt dryers or screw conveyor dryers.

The contact dryer is preferably selected from at least one of
a rotatable steam tube bundle dryer in a static housing;
a rotatable tube bundle dryer (also known as an indirect rotary dryer);
a thin film dryer; or
a contact drum dryer;
cylinder dryers;
steam-belt dryers; or
screw conveyor dryers.

Preferably, the contact dryer is a rotatable steam tube bundle dryer in a static housing. This means that the individual tubes are rotatable, so that the composition to be dried can fall between the tubes when they are heated with the vapours.

In a rotary tube bundle dryer, the entire housing is rotatable, rather than the individual tubes.

The thin film dryer can be an agitated or turbo dryer.

The installation may also comprise more than one contact dryer, which may be installed either sequentially (if a product must be dried multiple times to reach the desired moisture content) or in parallel (for example for increased capacity/throughput). Multiple dryers can be connected as needed with further connecting means between said dryers.

The inventors have found that in conventional contact dryers, depending on the composition to be dried, the surface(s) of the contact dryer in constant contact with the process vapours may rapidly begin to degrade. Without being bound by theory, due to the set-up of the installation and the re-use of process vapours, it has been found that the process vapours can be acidic, particularly if the composition to be dried contains food or feed. The pH in that case may range from as low as 2-6. This means that conventional contact dryers are not suitable for the installation and process when applied to drying compositions that create acidic vapours, for instance compositions of food or feed. In this case, it was found that preferably the surface(s) of the contact dryer in contact with the process vapours should be made of acid-resistant material. More preferably, the contact dryer's surface(s) (and preferably any other surface of the installation) in contact with process vapours are made from stainless steel, titanium or alloys thereof. Specific examples include stainless steel alloy 316Ti (e.g. DIN/EN designation No. 1.4571).

The dryer can be run under vacuum, under overpressure or under atmospheric pressure. Preferably, the dryer is run under a slight overpressure i.e. up to 50 mbar above atmospheric pressure, more preferably up to 20 mbar above atmospheric pressure, most preferably up to 10 mbar above atmospheric pressure. Operating the dryer under a slight overpressure stops air from entering the installation during its use.

2.2. The Purifying Apparatus (Optional)

The installation suitable for drying a water-containing composition of solid matter preferably further comprises one or more purifying apparatus(es). Depending on the product to be dried, the process vapours originating from the contact dryer can be transported to one or more purifying apparatus(es) via a first connecting means. The purifying apparatus(es) should be suitable for reducing the level of any impurities in the process vapours. By impurities it is meant herein any small particles/particulates/powder/dust that may be originate from the composition to be dried.

It has also been found that when drying certain compositions, such as those containing food or feed, the process vapours may be acidic. In this case, it is also possible to neutralise the acidity or at least increase the pH in the purifying apparatus by the addition of base in the purifying apparatus.

Alternatively, but less preferred, a further mixing apparatus can be included between the scrubber and the compressor along the second connecting means to allow for the addition of base.

Surprisingly, the inventors have found that by applying a purifying apparatus to remove impurities/particulates in the process vapours, the risk of fouling and the risk of rapidly wearing out the downstream vapour compressor is significantly reduced, such that the installation and process become industrially and economically feasible.

Preferably, the purifying apparatus is selected from a scrubber or a filter system. More preferably the purifying apparatus is a scrubber, even more preferably a wet scrubber.

One or more purifying apparatus(es) can be used. Preferably only one purifying apparatus is used.

When more than one purifying apparatus is used, these can be installed sequentially or in parallel.

Preferably the surface(s) of the purifying apparatus(es) in contact with the process vapours are made of acid-resistant material to resist potentially acidic process vapours. More preferably, the surface(s) in contact with process vapours are made of stainless steel, titanium or alloys thereof. Specific examples include stainless steel alloy 316Ti (e.g. DIN/EN designation No. 1.4571).

2.3. The Vapour Compressor

The vapour compressor is suitable for increasing the temperature and the pressure of the purified process vapours. This type of compression is also known as mechanical vapour recompression (MVR).

Preferably, the vapour compressor is selected from at least one of:
a screw compressor;
a centrifugal compressor;
a turbocompressor;
a scroll compressor; or
a piston compressor;

More preferably, the vapour compressor is a screw compressor, even more preferably a dry screw compressor. Surprisingly, it was found that the screw compressor can better withstand process impurities and particles remaining in the process vapours even after the purifying apparatus, whilst providing a high compression ratio and thereby a significant temperature lift, preferably in a single stage process i.e. in an open system.

Preferably, the vapour compressor is run electrically. This is mainly for environmental reasons. For example, a wind turbine or a solar panel can be used to create the electricity needed to run the vapour compressor.

The application of such a vapour compressor is surprisingly advantageous because
the installation can be a stand-alone installation (no synchronisation needed with other operations in a plant in order to reuse the recovered energy on the spot)
the vapour compressor can be run on medium/low speed (3000-6000 rpm), so it can have an extended lifespan;
the vapour compressor is robust and therefore less vulnerable to particulates coming through the scrubber operation.

The vapour compressor as used according to the invention may be part of a heat pump circuit. Many heat pump circuits known in the art may comprise a compressor as a secondary system. These are also known as closed systems. Recompression is thereby carried out by a two-stage process.

However, preferably the installation according to the invention does not comprise a closed heat pump circuit. The vapour compressor according to the invention is thus not part of a closed heat pump circuit. The vapour compressor can thereby operate as a one stage process. The recompression of the process vapours is thus in an open system. It has been found that using a vapour compressor in the absence of a heat pump circuit allows a higher efficiency gain.

Preferably the surface(s) of the vapour compressor(s) in contact with the process vapours are made of acid-resistant material to resist potentially acidic process vapours. More preferably, the surface(s) in contact with process vapours are made of stainless steel, titanium or alloys thereof. Specific examples include stainless steel alloy 316Ti (e.g. DIN/EN designation No. 1.4571).

2.4. “Connecting Means”

The term “connecting means” means herein any means suitable for the passage of process vapours from one part of the installation to another as required by the invention. Preferably, the connecting means is any sort of conduit, tube, pipe, piping, tubing, hose, channel, canal or duct suitable for the passage of said process vapours.

Preferably the surface(s) of the connecting mean(s) in contact with the process vapours are made of acid-resistant material to resist potentially acidic process vapours. More preferably, the surface(s) in contact with process vapours are made of stainless steel, titanium or alloys thereof. Specific examples include stainless steel alloy 316Ti (e.g. DIN/EN designation No. 1.4571).

2.5. Injecting Means

Fresh vapour (steam) injection is needed to start up the drying process. Thereafter, the addition of fresh vapour (steam) is optional.

Fresh vapour (steam) injection is typically needed when energy losses in the process (for instance, insulation losses and other minor inefficiencies) cannot be completely compensated by the energy input of the compressor. Furthermore, in case of maintenance or required repair of the vapour compressor, a fresh vapour source is useful as a back-up in order to be able to continue to run the installation for drying (without energy recovery).

As an example, up to 10% of the total heat capacity of the contact dryer may originate from the fresh vapour injected into the installation. Furthermore, the inventors found that the fresh vapours are preferably injected between the vapour compressor and the contact dryer. The fresh vapours are preferably injected at a minimal overpressure (more preferably less than 100 mbar above the pressure of the process vapours in the connecting means) and at saturation temperature. Preferably, the fresh vapours are steam, more preferably saturated steam. Preferably, the fresh vapours originate from a boiler.

The installation may therefore further comprise an injecting means suitable for injecting fresh vapours into a (third) connecting means, which connects the vapour compressor with the dryer. Preferably, fresh vapours are injected into the third connecting means in an amount suitable for compensating heat losses occurring during the use of the installation.

2.6. A Separator

Furthermore, after the contact dryer the non-condensables and the condensed vapour can enter a separator. The non-condensables are preferably separated in order to evacuate the condensate as a pure liquid stream. The installation according to the invention may thus further comprise a separator connected to said contact dryer suitable for separating non-condensables originating from the product in the contact dryer. The separator can be a small open tank where non-condensables are flashed off.

### 3. The Vapours

The preferred process vapours are the water vapours emanating from the composition of solid matter during the drying process. Thus, the fresh vapour injected into the system is preferably steam, more preferably saturated steam.

The process vapours are preferably saturated, so that they do not contain any droplets/condensation.

### EXAMPLE ACCORDING TO THE INVENTION

### Example 1

### The Installation

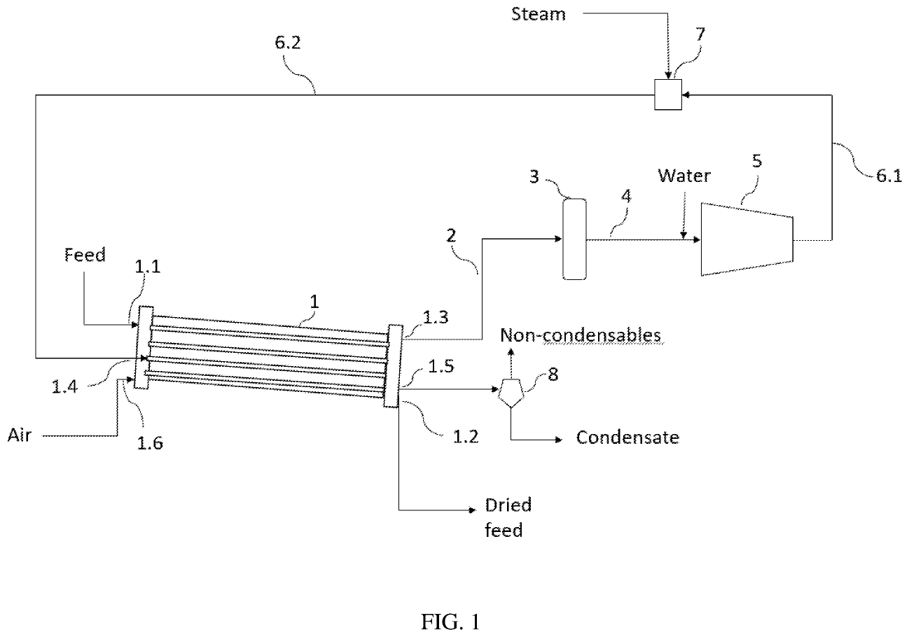

As shown in FIG. 1, the following installation was provided. A rotatable steam tube bundle dryer (1) suitable for drying a feed stream of stillage obtained from a side stream of a wheat processing facility for starch production was set up. The dryer featured a feed inlet (1.1) into the dryer, as well as an outlet for the dried feed (1.2) and an outlet for the process vapours (1.3). The dryer also had an inlet (1.4) for the process vapours/fresh vapours and an inlet for air (1.6), as well as an outlet for the mixture of condensate and non-condensables (1.5).

The dryer (1) was connected at the outlet of the process vapours (1.3) via a first connecting means (2) to an inlet of a wet scrubber (3). The scrubber (3) was connected at an outlet via a second connecting means (4) to an inlet of a dry screw compressor (5). The screw compressor (5) was connected at the outlet via a third connecting means (6) to the vapour inlet (1.4) of the dryer (1). An injecting means (7) was provided into the third connecting means (6) suitable for injecting fresh steam into the system.

The dryer outlet for the mixture of condensates and non-condensables (1.5) was connected to a separator (8) suitable for separating the mixture into condensate and non-condensables (for example, air).

A means to also add water into the screw compressor (5) to enhance saturation of the process vapours was provided.

Where possible, in particular in the conduits, the dryer, the scrubber and the screw compressor, the surfaces in the installation in contact with the process vapours were made predominantly of an acid resistant material, namely a stainless steel alloy 316Ti with DIN/EN designation No. 1.4571.

### The Drying Process

A composition of stillage, bran and recycled material (“recycle”) destined as feed was dried according to the drying process of the invention using an installation shown in FIG. 1. The recycle refers to product that has already been dried once and is reinserted into the dryer along with fresh product for drying to avoid stickiness of the product in the dryer.

TABLE 1

| | | | | % of |
|---|---|---|---|---|
| | Total | Moisture | DS | total |
| Feed | kg/h | kg/h | kg/h | feed |
| Stillage | 5823 | 4134 | 1689 | 14 |
| Bran | 3722 | 447 | 3275 | 9 |
| Recycle | 21192 | 2119 | 19073 | 52 |
| Feed at the dryer inlet | 30737 | 6700 | 24037 | |

The conditions were measured throughout the drying process in the installation, which are shown in Table 2 below.

TABLE 2

| | | | Dried | | | Saturated | | Vapor to | | Non- | |
|---|---|---|---|---|---|---|---|---|---|---|---|
| | | Feed to | feed from | Vapor from | | vapor in | Steam | dryer in | Air To | condensables | Condensate |
| | | Dryer at | Dryer at | dryer at | Com- | connecting | injection at | connecting | Dryer at | (Air) from | from |
| | | inlet | outlet | outlet | pressor | means | injector | means | inlet | separator | separator |
| | | (1.1) | (1.2) | (1.3) | (5) | (6.1) | (7) | (6.2) | (1.6) | (8) | (8) |
| Mass | kg/hr | 30,737 | 26,707 | 4,080 | | 4,571 | 750 | 5,321 | 50 | 313 | 5,008 |
| flow | | | | | | | | | | | |
| Temper- | ° C. | 87.6 | 114.3 | 114.3 | | 138.7 | 250 | 150.3 | 11.0 | 136.9 | 133.6 |
| ature | | | | | | | | | | | |
| Pressure | bar | 1.0 | 1.0 | 1.0 | | 3.5 | 17.0 | 3.5 | 1.0 | 3.5 | 3.5 |
| Feed | kg/kg | 0.78 | 0.90 | 0 | | 0 | | 0 | 0 | 0 | 0 |
| Water | kg/kg | 0.22 | 0.10 | 0.99 | | 0.99 | 1.0 | 0.99 | 0.005 | 0.84 | 1.00 |
| Power | kW | | | | 408 | | | | | | |
| input | | | | | | | | | | | |

The composition of solid matter was successfully dried from a moisture content of 22 wt % down to 10 wt % by having a dryer operating at a temperature of around 140° C. The details of the dried product at the outlet of the dryer are shown in Table 3 below:

TABLE 3

| | Total | Moisture | DS |
|---|---|---|---|
| Product | kg/h | kg/h | kg/h |
| Product | 5515 | 552 | 4964 |
| Recycle | 21192 | 2119 | 19073 |
| Total at outlet | 26707 | 2671 | 24036 |
| of dryer | | | |
| | Evaporation | 4030 | |
| | from product | | |

The energy consumption required for the drying process using the installation according to FIG. 1 was compared to the energy consumption of a conventional steam tube bundle dryer (see Table 4 below). Substantially less energy input was needed to run the process according to the invention.

Surprisingly, less than 10% of the heat capacity in the form of vapours (process vapours and fresh steam) entering the dryer originates from the fresh steam. It was found that by addition of this fresh steam and operating the dryer at atmospheric pressure or slightly above atmospheric pressure (i.e. up to 10, 20 or 50 mbar above atmospheric pressure), the drawbacks from the use of process vapours with entrained air and particles could be overcome. The addition of fresh steam also allowed to compensate for minor heat losses during the process.

Furthermore, the acidity of the process vapours originating from the feed could be managed surprisingly well by using a dryer, connecting means (i.e. conduits), scrubber and screw compressor with surfaces in contact with the process vapours predominantly made of acid-resistant material, namely a stainless steel alloy. Conventional steam tube bundle dryers are not made of such materials, so this required substantial redesigning of some of the dryer's elements.

It was also observed that the dryer in the installation of the invention had to be substantially larger in order to create a larger surface area for the same throughput. This compensated for the temperature drop from 160° C. to 140° C. in the dryer and rendered the screw compressor more efficient.

The screw compressor itself was operable at low speed in a 1 stage process.

TABLE 4

| | Installation of the steam | | | Installation without a screw | | |
|---|---|---|---|---|---|---|
| | tube bundle dryer of Example 1 | | | compressor and heat recovery | | |
| Energy | Power | 408 | kWh | Power | 0 | kWh |
| use: | Steam | 750 | kg/h | Steam | 4836 | kg/h |
| | Energy | 3403 | MJ/h | Energy | 12473 | MJ/h |
| | input | | | input | | |
| | Evapo- | 4030 | kg/h | Evapo- | 4030 | kg/h |
| | ration | | | ration | | |
| | Spec. | 0.844 | MJ/kg | Spec. | 3.1 | MJ/kg |
| | Energy | | | Energy | | |

1. An installation suitable for drying a water-containing composition of solid matter comprising:
(i) one or more contact dryer(s) for drying said composition of solid matter using the heat of vaporisation from process vapours, comprising a process vapour outlet and a process vapour inlet;
(ii) a vapour compressor for compressing the process vapours to increase the temperature and pressure of said process vapours, comprising a process vapour inlet and a process vapour outlet;
wherein the process vapour outlet of the one or more contact dryer(s) is connected either directly or indirectly to the process vapour inlet of the vapour compressor and the process vapour outlet of the vapour compressor is connected either directly or indirectly to the process vapour inlet of the one or more contact dryer(s).

2. The installation according to claim 1 further comprising:
(iii) a first connecting means for transferring process vapours from said one or more contact dryer(s) to one or more purifying apparatus(es);
(iv) one or more purifying apparatus(es) suitable for reducing the level of any impurities/particles present in the process vapours;
(v) a second connecting means for transferring purified vapours from said one or more purifying apparatus(es) to the vapour compressor;
(vi) optionally a means for injecting fresh vapours into a third connecting means, which connects the vapour compressor to the one or more contact dryer(s).

3. The installation according to claim 1 wherein the contact dryer is chosen from
a rotatable steam tube bundle dryer in a static housing;
a rotatable tube bundle dryer;
an thin film dryer; or
a contact drum dryer.

4. The installation according to claim 1, wherein the installation is a stand-alone unit not connected to any other installation.

5. The installation according to claim 1, wherein surfaces of the contact dryer in contact with the process vapours are made from an acid-resistant material.

6. The installation according to claim 2, wherein the purifying apparatus (3) is selected from a scrubber or a filter system.

7. The installation according to claim 1, wherein the vapour compressor is selected from one of:
a screw compressor;
a centrifugal compressor;
a turbocompressor;
a scroll compressor; or
a piston compressor.

8. The installation according to claim 1, wherein the installation does not comprise a closed heat pump circuit.

9. A process for drying a water-containing composition of solid matter comprising the following steps:
(i) drying the composition of solid matter in a contact dryer, wherein the heat for drying the composition is generated from process vapours and optionally fresh vapours;
(ii) optionally transferring the process vapours from the contact dryer to one or more purifying apparatus(es) to reduce the level of any impurities/particles in the process vapours in said purifying apparatus(es) before transferring the purified process vapours from said purifying apparatus(es) to a vapour compressor;
(iii) compressing the (optionally purified) process vapours in a vapour compressor;
(iv) transferring the compressed process vapours into the contact dryer;
(v) optionally injecting fresh vapours into a connecting means which connects the vapour compressor to the contact dryer; and
(vi) recovering from the contact dryer a dried composition of solid matter.

10. A The process according to claim 9 wherein the composition of solid matter to be dried is selected from:
stillage obtained during the production of starches and sweeteners from cereals, comprising corn or wheat;
cereals, cereal grains, cereal endosperms, cereal germs, cereal bran or cereal derived products comprising cereal flakes, starches (native or modified), maltodextrins, or syrups, wherein the cereal can be corn or maize, rice, wild rice, wheat (comprising spelt, einkorn, emmer, durum and kamut), barley, sorghum, millet, oats, rye, triticale and mixtures thereof;
distillers grains, comprising wet distillers grains (WDG) and dried distillers grains with solubles (DDGS), wherein the distillers grains are a cereal byproduct of the distillation process from beer breweries, distilleries and bioethanol plants, and wherein the cereal can be corn or maize, rice, wild rice, wheat comprising spelt, einkorn, emmer, durum and kamut; barley, sorghum, millet, oats, rye, triticale and mixtures thereof;
fibrous material comprising fibres such as wood fibres comprising groundwood, lacebark, thermomechanical pulp and bleached or unbleached kraft or sulfite pulps; vegetable fibres comprising bamboo, cotton, hemp, jute, flax, ramie, sisal, bagasse, banana and coconut fibres; dietary fibres comprising soluble fibres and insoluble fibres whether synthetic or natural or derived naturally or derived from nature and animal fibres;
other foodstuffs and fat- or protein- or lipid- or dietary fibre-containing compositions;
detergents in the form of washing powders and
salt, mined or produced from seawater.

11. The process according to claim 9 wherein the composition of solid matter is stillage or distillers grains.

12. The process according to claim 9 wherein the process does not depend on or connect with any energy requirements unrelated to or outside of the process.

13. A process for improving the energy efficiency of a contact dryer comprising by using a vapour compressor capable of at least partially recovering the heat of vaporisation from the process vapours originating from the contact dryer and reusing the heat in the contact dryer and
wherein the recovered heat of vaporisation is used in the same contact dryer for drying.

14. The process according to claim 13, wherein the contact dryer is configured for drying water-containing compositions of solid matter to recover at least partially the heat of vaporisation from the process vapours originating from the composition being dried in the contact dryer by recompressing the process vapours.

15. The process according to claim 13, wherein the contact dryer is configured for drying water-containing compositions of solid matter to increase the energy efficiency of the installation compared to the same installation, which does not comprise a vapour compressor, or compared to the same installation, comprising a heat pump circuit.

16. The installation according to claim 5, wherein the acid-resistant material comprises stainless steel, titanium, or alloys thereof.

17. The installation according to claim 6, wherein the purifying apparatus comprises a wet scrubber.

18. The process according to claim 9, wherein compressing the (optionally purified) process vapours in a vapour compressor comprises a one-stage process.

19. The process according to claim 11, wherein the composition of solid matter is wet distillers grains (WDG).
